(19) United States
(12) Patent Application Publication
(10) Pub. No.: US 2010/0020061 A1
(43) Pub. Date: Jan. 28, 2010

(54) DISPLAY DEVICE AND METHOD OF DRIVING THE DISPLAY DEVICE

(75) Inventors: Katsuhiro Kanauchi, Yamagata (JP); Akinori Hayafuji, Yamagata (JP); Shuichi Seki, Yamagata (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: PIONEER CORPORATION, Tokyo (JP); TOHOKU PIONEER CORPORATION, Tendo-shi, Yamagata (JP)

(21) Appl. No.: 12/440,836

(22) PCT Filed: Oct. 25, 2006
(86) PCT No.: PCT/JP2006/321239

§ 371 Date: Jul. 2, 2009

(51) Int. Cl. G06F 3/038

(52) U.S. Cl. 345/213

(57) ABSTRACT

A display panel 1, in which light-emitting elements E11 to EMN are connected in a matrix state to the respective intersecting positions of a plurality of signal lines A1 to AM and a plurality of scan lines K1 to KN, is used. A scan line Kn is set to a scan selection potential (ground potential), and a pulse voltage from a pulse power supply 4 is applied to the other scan lines. When switches Sa1 to SaM as data selection means in a data driver 2 are placed in a state shown in a drawing, respective currents are applied to light-emitting elements to be emitted in a forward direction as rush currents through the parasitic capacitances of light-emitting elements in a non-scan state when the pulse voltage rises.

### TECHNICAL FIELD

The present invention relates to a display device using capacitive elements, for example, organic EL (electro-luminescence) elements and the like as display pixels and a drive circuit thereof.

### BACKGROUND ART

A display using a light-emitting display panel composed of light-emitting elements disposed in matrix is being widely developed. Attention is paid to an organic EL element, which uses an organic material for a light-emitting layer, as a light-emitting element used to the display panel. This is based on such a background that the efficiency of an EL element is enhanced to a level capable of withstanding a practical use and the life thereof is prolonged by using an organic compound, to which excellent light-emitting characteristics are expected, for a light-emitting layer of the EL element.

The above organic EL element is basically formed by laminating a transparent electrode constituting an anode, a light-emitting function layer containing an organic compound, and, for example, a metal electrode constituting a cathode on a transparent substrate. Accordingly, the organic EL element can be electrically replaced by a light-emitting element having diode characteristics and a parasitic capacitance component coupled in parallel with the light-emitting element, and thus it can be said that the organic EL element is a capacitive light-emitting element.

A passive drive type display panel, on which organic EL elements are disposed in matrix, has been partly in practical use as a display panel using the organic EL element. FIG. 1 shows an example of a conventional passive matrix display panel and a drive circuit thereof.

A display panel 1 is composed by disposing M pieces of signal lines (hereinafter, also referred to as anode lines) A1 to AM in a longitudinal direction, disposing N pieces of scan lines (hereinafter, also referred to as cathode lines) K1 to KN in a lateral direction, and disposing organic EL elements (hereinafter, also referred to as light-emitting elements) E11 to EMN shown by parallel coupling members of diodes as light-emitting elements and capacitors as parasitic capacitances at the respective intersecting points (M×N positions in total) of the signal lines and the scan lines.

Then, one ends of the respective EL elements E11 to EMN which constitute pixels (anode terminals in equivalent diodes of the EL elements) are connected to the anode lines, and the other ends (cathode terminals in the equivalent diodes of the EL elements) are connected to the cathode lines in correspondence to the respective intersecting points of the anode lines A1 to AM along a vertical direction and the cathode lines K1 to KN along a horizontal direction. Further, the respective anode lines A1 to AM are connected to an anode line drive circuit 2 as a data driver, the respective cathode lines K1 to KN are connected to a cathode line scan circuit 3 as a scan driver, and they are driven by the drivers, respectively.

The anode line drive circuit 2 has constant current sources I1 to IM operating by making use of a drive voltage Vah and drive switches Sa1 to SaM and acts so that the currents supplied from the constant current sources I1 to IM are supplied to the respective EL elements E11 to EMN disposed in correspondence to the cathode lines by connecting the drive switches Sa1 to SaM to the constant current sources I1 to IM sides. Further, when the drive switches Sa1 to SaM do not supply the currents from the constant current sources I1 to IM to the respective EL elements, they are arranged to be connected to a ground side using the anode line as a reference potential point.

In contrast, the cathode line scan circuit 3 has scan switches Sk1 to SkN in correspondence to the respective cathode lines K1 to KN and acts to apply any one of a reverse bias voltage Vkh for preventing crosstalk emission or a ground potential as the reference potential point to a corresponding cathode line. With this operation, the cathode line scan circuit 3 acts to cause the respective EL elements to selectively emit light by connecting the constant current sources I1 to IM to desired ones of the anode lines A1 to AM while setting the cathode lines to the reference potential point (ground potential) at a predetermined cycle.

Note that, in the state shown in FIG. 1, an n-th cathode line Kn is set to the ground potential and placed in a scan state, and at the time, and the reverse bias voltage Vkh is applied to the cathode lines in a non-scan state. Accordingly, the crosstalk emission of the respective EL elements, which are connected to the intersecting points of the anode lines being driven and the cathode line whose scan is not selected, is prevented.

Incidentally, the EL elements constituting the display panel have the parasitic capacitances described above. Thus, as to an example in which, for example, N pieces of the EL elements are connected to one signal line (anode line), synthesized capacitances N times as large as the respective parasitic capacitances are connected to the signal line as a load capacitance when viewed from the signal line.

Accordingly, a problem arises in that the current from the anode lines is consumed to charge the load capacitance at the beginning of a scan period, a time delay occurs to charge the load capacitance until the light emission threshold voltage (Vth) of the EL elements is sufficiently exceeded, and eventually the start-up of emission of the EL elements is delayed. In particular, when the constant current sources I1 to IM are used as a drive source as described above, since the constant current sources are a high impedance output circuit from the operating principle thereof, a current is restricted and thus the start-up of emission of the EL elements is prominently delayed.

FIGS. 2A to 2C are views explaining the technical problems described above, wherein FIG. 2A is a view showing one signal line of the display panel shown in FIG. 1 by an equivalent circuit. More specifically, since all the non-selected scan lines other than an n-th scan line are connected to the reverse bias voltage Vkh, they are regarded as “being connected in parallel”. However, since the EL elements (diode components) of the non-selected scan lines are biased in a reverse direction, they are substantially equivalent to open (released).

Further, since the capacitances parasitizing to the EL elements of the non-selected scan lines are connected in parallel when a parasitic capacitance of one pixel is shown by Cpix, the capacitances can be shown by (N−1)·Cpix. Accordingly, the equivalent circuit shown in FIG. 2A can be shown as in FIG. 2B.

In a circuit arrangement shown in FIG. 2B, when a current Ia is injected from an anode constant current source, since the non-selected scan lines are connected to a constant voltage source (equivalent to the ground from a view point of an alternate current), the injected current is shunted as shown by Ia=Ins+Is. At the time, a current flows out to the non-selected scan lines until the time change (dv/dt) of an anode voltage is set to “0”, and the anode voltage when dv/dt=0 is set to Vf(Ia).

Further, the amount of flowing-out current is more increased when the non-selected scan lines have larger parasitic capacitances (N−1)·Cpix (when the number of the scan lines is larger). As a result, the emission of the EL elements connected to the selected scan line is delayed as shown by Is in FIG. 2C, and an ineffective power corresponding to Ins flowing from the constant current source at the time is also increased.

There are proposed a “peak boot method” and a “rush current method” as means for improving the emission start-up characteristics of the EL elements to be scanned, and these methods are disclosed in Patent Documents 1 and 2 and the like applied by the present applicants.

Patent Document 1: Japanese Patent Application Laid-Open Publication No. 9-232074

Patent Document 2: Japanese Patent Application Laid-Open Publication No. 2002-229512

Note that the “rush current method” is arranged such that the parasitic capacitances of all the EL elements are reset to a constant charge amount each time a scan is performed, and there are proposed a “Vm-Vm reset method”, a “GND-GND reset method”, a “Vm-Vr reset method”, and the like depending on a type of a potential applied to both the ends of the EL elements.

### DISCLOSURE OF THE INVENTION

### Problems to be Solved by the Invention

Incidentally, according to a drive unit of the conventional display panel shown in FIG. 1, the constant current sources I1 to IM must be provided in correspondence to the respective signal lines to drive the EL elements as the light-emitting elements disposed to the display panel, from which a problem arises in that a circuit arrangement is made complex by providing them.

Further, when the constant current sources are arranged as an IC chip, since it is difficult to reduce the size thereof, an increase of cost is indispensable. Further, the constant current must have a certain degree of voltage drop to provide it with constant current characteristics, which acts as a factor for causing a power loss.

To solve the problems described above, it is also contemplated to drive the EL elements by a constant voltage. However, in this case, the degree of light emitting luminance of the EL elements is extremely changed by the environmental temperature and the change over time, from which a problem arises in that the EL elements cannot be practically used unless a countermeasure is employed.

Accordingly, an object of the present invention is to provide a display device and a method of driving the display device which simplify an arrangement of the data driver by providing a function which is replaced with the constant current sources by positively utilizing the operating principle of the “rush current method”.

### Means for Solving the Problems

FIG. 3A to FIG. 3C explain the operating principle of the “GND-GND reset method” described above as well as explain a basic idea of the present invention which has developed the “GND-GND reset method”. More specifically, FIG. 3A shows one signal line of the display panel shown in FIG. 1 using an equivalent circuit and shows a state in which all the signal lines as well as all the scan lines are connected to a ground (GND) potential and the charges accumulated in the parasitic capacitances of respective EL elements are discharged.

Subsequently, as shown in FIG. 3B, a reverse bias voltage Vkh is connected to the non-selected scan lines other than a scan line to be scanned, and the scan line to be scanned remains set to the ground potential. With this arrangement, since a closed circuit, to which a voltage source Vkh is connected through a capacitance (N−1) Cpix, is formed to the selected EL element, a rush current (Irush) is supplied to the selected EL element through the capacitance in a forward direction. Note that, although a constant current source is connected to the anode side of the selected EL element at the time, since the constant current source constitutes a high impedance circuit, it does not affect the above operation.

Accordingly, the anode terminal voltage of the selected EL element reaches a voltage near to Vkh as shown in FIG. 3C. Then, since a charge is injected to parasitic capacitances of the non-selected EL elements, anode terminal voltages drop as a time passes and are finally set to a light emission threshold voltage (Vth) of the EL elements.

An amount of the charge Q injected to the parasitic capacitances of the EL elements at the time can be shown as follows.

Q=(N−1)·Cpix·(Vkh−Vth) (Expression 1)

Note that, for the purpose of simplification, N is set to a sufficiently large value and the parasitic capacitances Cpix of the selected EL elements are omitted.

Further, when it is assumed Vth≈Vf (Vf is a forward voltage of the EL elements) in Expression 1 in consideration of diode characteristics of the EL elements, Q can be shown as follows.

$$\begin{matrix}Q \approx ( N - 1 ) \cdot Cpix \cdot ( Vkh - Vel ) \\ = ( N - 1 ) \cdot Cpix \cdot ( ( Vkh - ( Vf + Δ Vf ) )\end{matrix} \qquad ( Expression 2 )$$

From Expression 2, the amount of charge injected to the selected EL element can be set to a constant value by setting Vkh to a value sufficiently larger than ΔVf which is an amount of change of Vf caused by an environment temperature and a change over time. More specifically, a drive near to a constant current drive can be realized. Further, Expression 2 suggests that the amount of charge injected to the selected EL element can be changed by the number N cathode lines for realizing a rush current and the cathode voltage Vkh, and it is considered that this can be applied to a dimmer control for controlling the overall brightness of the entire display surfaces, and the like.

As disclosed in first aspect of the invention, a display device according to the present invention, to which the basic principle achieved to solve the above problems is applied, has a plurality of signal lines and a plurality of scan lines which intersect with each other, a plurality of light-emitting elements connected between the plurality of signal lines and the plurality of scan lines, respectively at the respective intersecting points of the scan lines and the signal lines, a pulse power supply connected to at least one of the scan lines for outputting a pulse voltage, a data driver having a plurality of data selection means for selectively connecting the signal lines to non-light-emitting terminals connected to a non-light-emitting potential or to light-emitting terminals connected to rectifying means for interrupting a current flowing from the signal lines, and a scan driver having scan selection means for selectively connecting the scan lines to scan terminals connected to a scan selection potential.

Further, as described in eleventh aspect of the invention, a method of driving a display device made in order to solve the above problem is a method of driving a display device which has a plurality of signal lines and a plurality of scan lines which intersect with each other and a plurality of light-emitting elements connected between the plurality of signal lines and the plurality of scan lines, respectively at the respective intersecting points of the scan lines and the signal lines, and there are executed a scan line setting operation for setting a scan line to be scanned to a scan selection potential as well as applying a pulse voltage to at least one of the scan lines which are not scanned, and a light emission drive operation for supplying a rush current from the scan line to which the pulse voltage is applied to a light-emitting element to be emitted through a light-emitting element which is connected to a signal line to be selected and is not emitted a plurality of times in one scan period.

### BRIEF DESCRIPTION OF THE DRAWINGS

FIG. 1 is a circuit arrangement view showing an example of a conventional display device.

FIG. 2A is an equivalent circuit view explaining a light emitting operation of a light-emitting element performed in the display device shown in FIG. 1.

FIG. 2B is an equivalent circuit view explaining a light emitting operation of the display device following to FIG. 2A.

FIG. 2C is a timing chart explaining an aspect of a drive current supplied to a light-emitting element to be emitted.

FIG. 3A is an equivalent circuit view explaining an operation of a rush current method employed in the display device shown in FIG. 1.

FIG. 3B is an equivalent circuit view explaining an operation of the rush current method following to FIG. 3A.

FIG. 3C is a timing chart explaining an aspect of a drive current supplied to a light-emitting element by the rush current method.

FIG. 4 is a circuit arrangement view showing a first embodiment according to the present invention.

FIG. 5 is an equivalent circuit view explaining a light emitting operation of a light-emitting element performed in the circuit arrangement shown in FIG. 4.

FIG. 6 is a circuit arrangement view showing a second embodiment according to the present invention.

FIG. 7 is a circuit arrangement view showing a third embodiment according to the present invention likewise.

FIG. 8 is a circuit arrangement view showing a fourth embodiment according to the present invention likewise.

FIG. 9 is a circuit arrangement view showing a fifth embodiment according to the present invention likewise.

FIG. 10 is a circuit arrangement view showing a sixth embodiment according to the present invention likewise.

FIG. 11 is a circuit arrangement view showing a seventh embodiment according to the present invention likewise.

### EXPLANATION OF REFERENCE NUMERALS

1 display panel
2 data driver
3 scan driver
4 pulse power supply
5 power recovery circuit
6 booster circuit
A1 to AM signal line
C0 capacitor
D1 to DM rectifying means (diode)
E0, E1, E2 voltage source
E11 to EMN organic EL element (light-emitting element)
K1 to KN scan line
S0, S1, S2 switch
Sa1 to SaM data selection means (switch)
Sk1 to SkN scan selection means (switch)

### BEST MODE FOR CARRYING OUT THE INVENTION

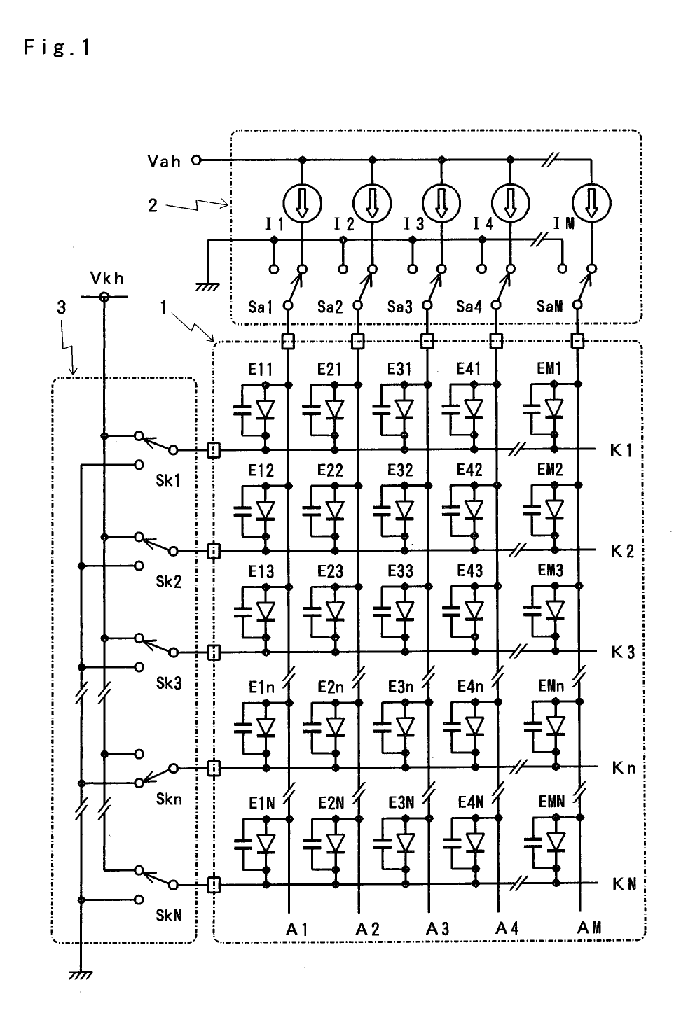

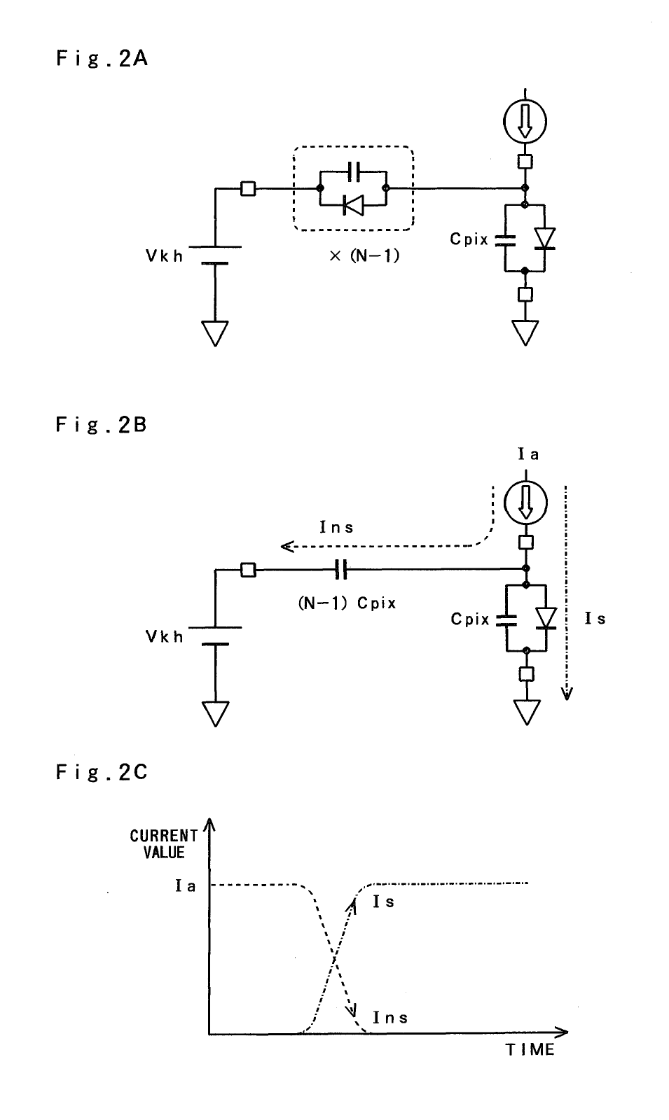

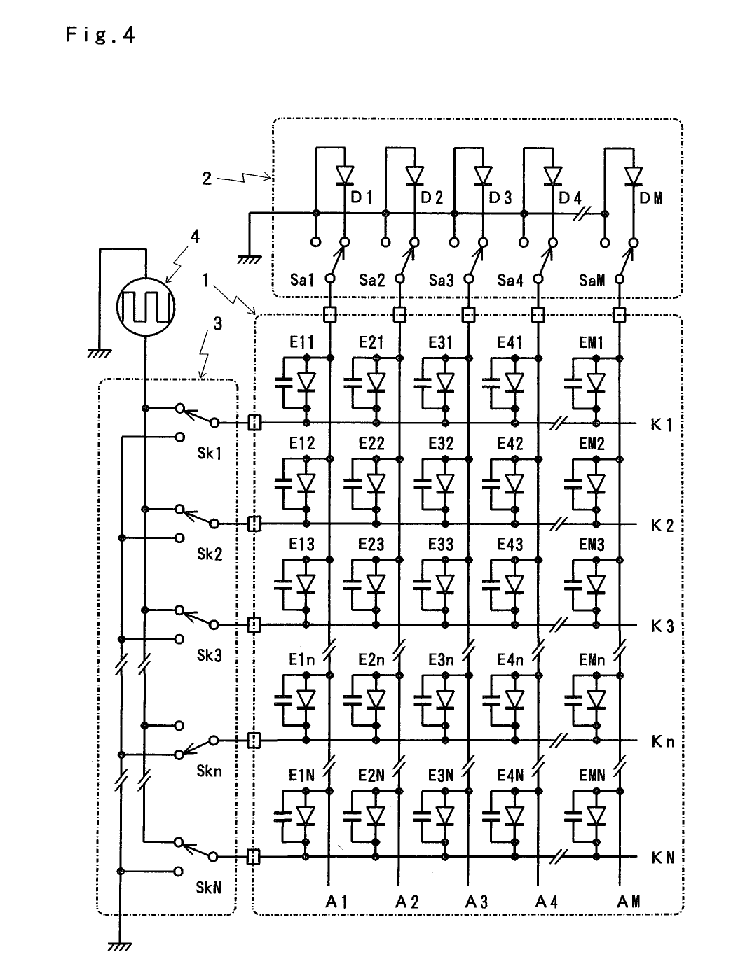

A display device according to the present invention will be explained below based on embodiments shown in the figures. FIG. 4 shows a first embodiment of the display device, and a reference numeral 1 shows the display panel already explained based on FIG. 1. Note that since an arrangement of the display panel is the same as that shown in FIG. 1, the explanation thereof is not repeated.

A data driver 2 of the embodiment shown in FIG. 4 has switches Sa1 to SaM as data selection means for selectively connecting respective signal lines A1 to AM disposed to the display panel 1 to light emitting terminals or to non-light-emitting terminals. More specifically, cathode terminals of diodes D1 to DM as rectifying means for interrupting a current flowing from the respective signal lines A1 to AM are connected to the light emitting terminals, and respective anode terminals thereof are connected to a ground potential. Further, the non-light-emitting terminals are connected to the ground potential as a non-light-emitting potential.

In contrast, a scan driver 3 has switches Sk1 to SkN as scan selection means for selectively connecting respective scan lines K1 to KN disposed to the display panel 1 to scan terminals. More specifically, the scan terminals are connected to the ground potential as a scan selection potential, thereby the respective scan lines K1 to KN can be alternatively set to the ground potential.

Further, in the embodiment shown in FIG. 4, a pulse power supply 4 is provided to output a pulse voltage, and a pulse voltage from the pulse power supply 4 is supplied to the non-scan terminal sides of the switches Sk1 to SkN as the scan selection means.

In the embodiment shown in FIG. 4, the scan driver 3 repeats an operation for sequentially setting the scan lines K1 to KN to the scan selection potential (ground potential) as in the example shown in FIG. 1. Each time the respective scan lines are scanned, the data selection means (switches Sa1 to SaM) in the data driver 2 performs an operation for connecting the respective signal lines A1 to AM to the light emitting terminals.

Note that FIG. 4 shows a state that an n-th scan line Kn is set to the ground potential and placed in a scan state and that, at the time, a pulse voltage from the pulse power supply 4 is supplied to the scan lines in a non-scan state. More specifically, when the pulse voltage is repeatedly supplied to the scan lines in the non-scan state in the state that the scan line Kn is placed in the scan state, the rush current explained already is repeatedly supplied to EL elements to be emitted.

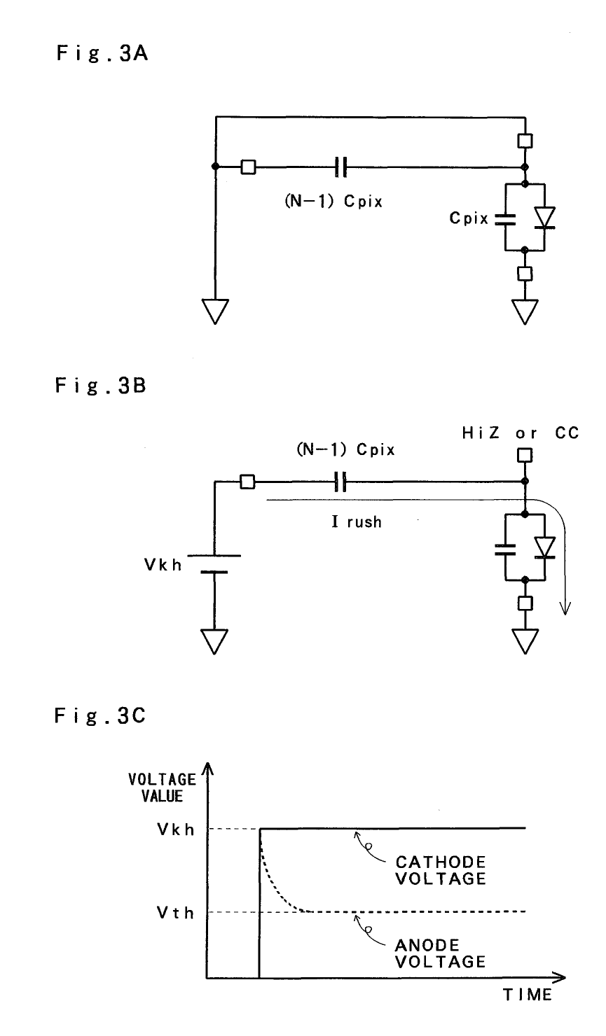

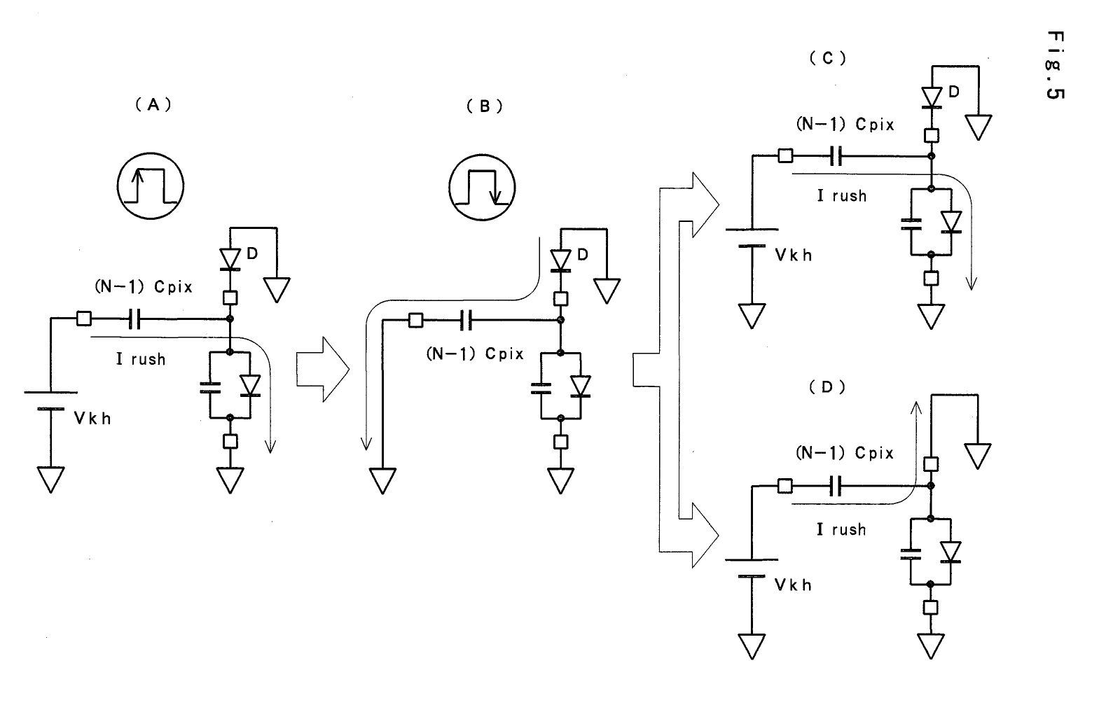

FIG. 5 explains a light emission control of an EL element performed in an arrangement shown in FIG. 4 and shows one signal line of the display panel shown in FIG. 4 by an equivalent circuit. More specifically, the equivalent circuit shown in FIG. 5 is similar to those already explained in FIGS. 3A and 3B, and additionally has ones (shown by a reference numeral D in FIG. 5) of diodes D1 to DM (hereinafter, also referred to as anode diodes) acting as rectifying means in the data driver 2 are connected to respective signal lines.

FIG. 5 (A) shows a state that a pulse voltage from the pulse power supply 4 rises and the voltage value (peak value) Vkh of the pulse voltage in this case. In the state shown in FIG. 5 (A), a charge resulting from the rising of Vkh is injected to selected EL elements by the rectifying action of the anode diodes D acting as rectifying means.

Subsequently, when a pulse voltage from the pulse power supply 4 falls as shown in FIG. 5 (B), the peak value Vkh is set to zero and equivalently placed in a ground state. Accordingly, the charges accumulated to the parasitic capacitances ((N−1)Cpix) of the EL elements of non-selected scan lines are discharged (GND-GND reset) through the anode diodes D.

Here, when FIG. 5 (C) shows a case in which the selected EL elements are emitted, that is to say, a case in which the switches as the data selection means in the data driver 2 in FIG. 4 are connected to the light emitting terminal sides (anode diode D sides). Further when FIG. 5 (D) shows a case in which the selected EL elements are not emitted, that is to say, a case in which the switches as the data selection means in the data driver 2 in FIG. 4 are connected to the non-light-emitting terminal sides (ground potential).

More specifically, when the selected EL elements are emitted, (A) and (B) of FIG. 5 are repeated according to rising and falling of a pulse voltage from the pulse power supply 4, and each time the pulse voltage rises and falls, the rush current flows to the selected EL elements to thereby emit the selected EL elements. Further, when the selected EL elements are not emitted, the rush current is caused to directly flow to the ground potential and almost no rush current flows to the selected EL elements as shown in FIG. 5 (D).

Accordingly, the gradation of the EL elements to be emitted can be controlled by controlling how many times the transitions shown in (A) and (B) of FIG. 5 for emitting the selected EL elements are repeated in one scan period (by controlling the number of pulses). More specifically, the gradation can be controlled by controlling the period of time in which the switches as the data selection means in the data driver 2 are connected to the light emitting terminal sides (anode diode D sides) in one scan period, that is to say, by controlling the timing at which the data selection means is switched according to gradation data.

Note that in the arrangement shown in FIG. 4, parasitic diodes of n-channel FETs can be also used as the anode diodes D1 to DM as the rectifying means. In this case, since one FET, which acts as a switch and a diode, can also achieve the role of the diode, the arrangement of the data driver 2 can be more simplified. Further, a pulse waveform from the pulse power supply 4 is not limited a rectangular shape, and the same operation/working-effect can be also obtained even by, for example, a sine wave and a saw tooth wave.

In contrast, the dimmer control can be realized by variably controlling the amplitude (peak value), the frequency, or the pulse width (DUTY) of the pulse voltage supplied from the pulse power supply 4. Further, since the current value of the rush current is changed depending on the number of scan lines to which the pulse voltage is applied, the dimmer control can be also performed by variably controlling the number of the scan lines to which the pulse voltage is applied.

In this case, since dimmer control means controls the switches Sk1 to SkN as the scan selection means in the scan driver 3 shown in FIG. 4, the non-selected scan lines, to which the pulse voltage is not applied, are set in a high impedance (released) state although not shown in FIG. 4. Further, to reduce the peak value of the rush current, a plurality of the pulse power supplies 4 each having a different output phase of the pulse voltage may be prepared, and pulse outputs may be applied to the respective non-selected scan lines from different power supplies.

Incidentally, when the selected EL elements are caused not to emit light, sine the rush current directly flows to the non-light-emitting potential of the data driver 2, that is to say, to the ground potential as shown in FIG. 5 (D), power is lost thereby. Thus, it is considered to provide a power recovery circuit to recover the power which directly flows to the ground potential and lost.

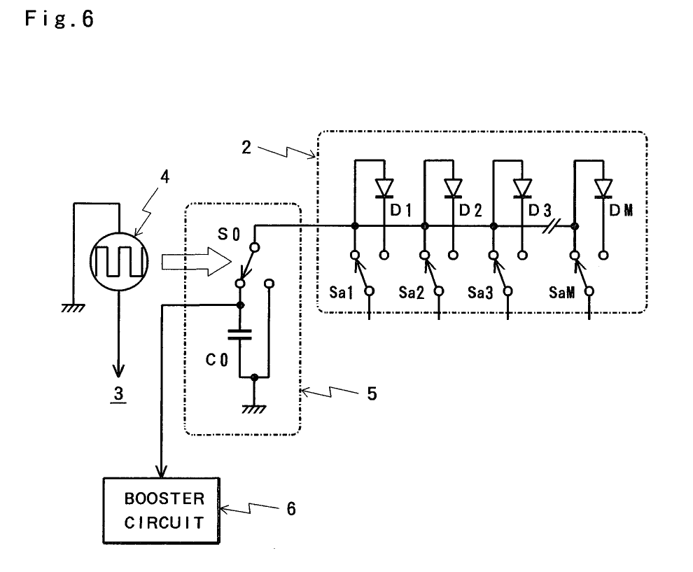

FIG. 6 shows a second embodiment according to the present invention and shows a connection arrangement in which the data driver 2 shown in FIG. 4 is provided with a power recovery circuit 5. Note that FIG. 6 does not show illustration of the display panel 1 and the scan driver 3 shown in FIG. 4.

The power recovery circuit 5 is composed of a timing switch S0 and a capacitor C0 having a large capacitance. The timing switch S0 is switched in synchronization with the times at which a pulse voltage supplied from a pulse power supply 4 rises and falls, and the capacitor C0 accumulates the rush current which tends to directly flow to the ground potential through the timing switch S0.

Then, a terminal voltage of the capacitor C0 is supplied to a booster circuit 6 such as a DC-DC converter and the like. With this arrangement, the rush current discharged to a reference potential point (ground) can be utilized as a part of a power supply for driving a display device.

As can be understood from the above explanation, the timing switch S0 is connected to the capacitor C0 side when the pulse voltage of the pulse power supply 4 rises. At the time, as shown in FIG. 5 (D), the rush current, which is generated when selected EL elements are controlled not to emit light, is supplied to the capacitor C0 through the timing switch S0 and accumulated in the capacitor C0 as a charge.

In contrast, the timing switch S0 is connected to the ground potential when the pulse voltage in the pulse power supply 4 falls. With this operation, a GND-GND reset shown FIG. 5(B) can be realized without trouble. Note that the power recovery circuit 5 shown in FIG. 6 can be also employed in the other embodiments according to the present invention explained below likewise.

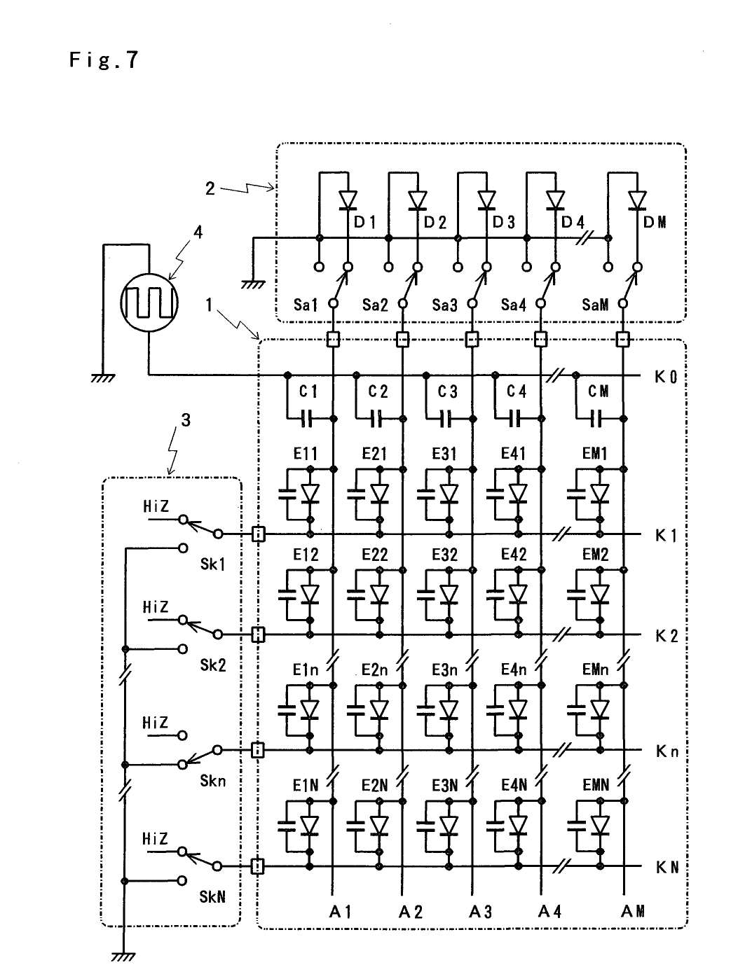

FIG. 7 shows a third embodiment of the display device according to the present invention. Note that since a data driver denoted by a reference numeral 2 in FIG. 7 has the same arrangement as that explained based on FIG. 4, the explanation thereof is not repeated.

In an arrangement shown in FIG. 7, a dummy scan line K0 is disposed in the display panel 1 shown in FIG. 1, and the pulse power supply 4 is connected to the dummy scan line K0. In the embodiment shown in FIG. 7, capacitors C1 to CM as capacitance elements, which do not contribute to display, are connected between the dummy scan line K0 and respective signal lines A1 to AM.

In contrast, a scan driver 3 has switches Sk1 to SkN as scan selection means for selectively connecting respective scan lines K1 to KN disposed to the display panel 1 to scan terminals. More specifically, the scan terminals are connected to the ground potential as a scan selection potential, thereby the respective scan lines K1 to KN can be alternatively set to the ground potential.

Note that FIG. 7 shows a case in which an n-th scan line Kn is set to the ground potential and placed in a scan state. In an arrangement of the scan driver 3 shown in FIG. 7, the scan lines other than a scan line to be scanned are set to a high impedance (released) side.

According to an arrangement shown in FIG. 7, a pulse voltage from the pulse power supply 4 is supplied to the respective signal lines A1 to AM through the dummy scan line K0 and the respective capacitors C1 to CM. More specifically, the respective capacitors C1 to CM arranges a capacitor ((N−1)Cpix) for creating the rush current shown in FIG. 5. Accordingly, a light emitting operation of EL elements can be realized by the rush current as in the example shown in FIG. 5 also in the arrangement shown in FIG. 7.

According to the arrangement shown in FIG. 7, since it is not necessary to apply the pulse voltage from the pulse power supply 4 to all the scan lines, the arrangement of the scan driver can be more simplified. Further, since EL elements have different light emitting luminance depending on the emitted color therefrom, a color balance can be adjusted by selecting the capacitances of the respective capacitors C1 to CM in accordance with the emitted color by the EL elements connected to the signal lines.

Further, when the capacitances of the respective capacitors C1 to CM are selected and adjusted in correspondence to the side where the switches Sk1 to SkN as the scan selection means are disposed, a phenomenon that the luminance of the EL elements is changed by the influence of a resistance existing in the scan lines, that is to say, the appearance of inclined luminance of the EL elements due to a cathode wiring resistance can be effectively suppressed.

Further, even in a mode in which pixels are not disposed in a dot matrix state in the display panel and which has different light emitting areas as in a segment and an icon, the balance of respective light emission luminances can be appropriately set by selecting the capacitances of the capacitors C1 to CM in correspondence to the mode.

Note that capacitive light-emitting elements such as EL elements and the like may be also used in place of the respective capacitors C1 to CM. When the light-emitting elements are caused to act as the respective capacitors C1 to CM, it is possible to perform a film forming process of EL elements acting as the respective capacitors C1 to CM simultaneously with a film forming process of respective EL elements when a display panel is molded. In this case, it is preferable to form masks on the upper surfaces of the EL elements and the like acting as the respective capacitors as necessary to prevent that they emit unnecessary light.

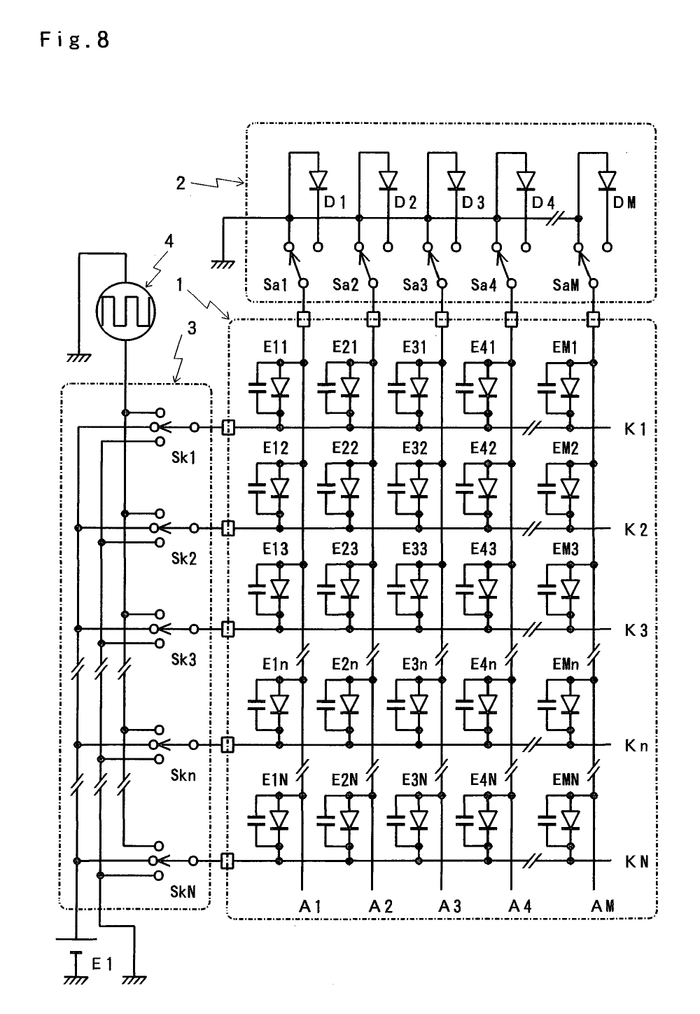

FIG. 8 shows a fourth embodiment of the display device according to the present invention. Note that since a display panel denoted by a reference numeral 1 and a data driver denoted by a reference numeral 2 in FIG. 8 have the same arrangements as those explained based on FIG. 4, the explanation thereof is not repeated.

In the arrangement shown in FIG. 8, a reverse bias voltage can be applied to respective the EL elements E11 to EMN disposed to the display panel 1. More specifically, it is known that the light emitting life of the respective EL element can be prolonged by regularly applying the reverse bias voltage thereto. For this purpose, in the arrangement shown in FIG. 8, a voltage source E1 is provided to apply the reverse bias voltage to the respective EL elements, and a positive pole voltage of the voltage source E1 is supplied to respective scan lines K1 to KN through a scan driver 3.

More specifically, the switches Sk1 to SkN as the scan selection means disposed to the scan driver 3 are provided with terminals for introducing the positive pole voltage of the voltage source E1. A negative terminal of the voltage source E1 is connected to the ground as a reference potential point of a circuit. When the switches Sk1 to SkN disposed to the scan driver 3 and switches Sa1 to SaM as data selection means disposed to the data driver 2 are selected such that they are placed in a state shown in FIG. 8, respectively, the EL elements E11 to EMN disposed to the display panel 1 are applied with the reverse bias voltage from the voltage source E1, respectively.

When the operation for applying the reverse bias voltage to the respective EL elements E11 to EMN is instantly performed to, for example, each one or each several frames, an effect of prolonging the life of the respective EL elements can be obtained without substantially adversely affecting an image displayed on the display panel 1.

Then, in the embodiment shown in FIG. 8, the same display operation as that of the embodiment explained based on FIG. 4 is performed except the case in which the reverse bias voltage is applied instantly to the respective EL elements E11 to EMN, a similar operation/working effect can be obtained.

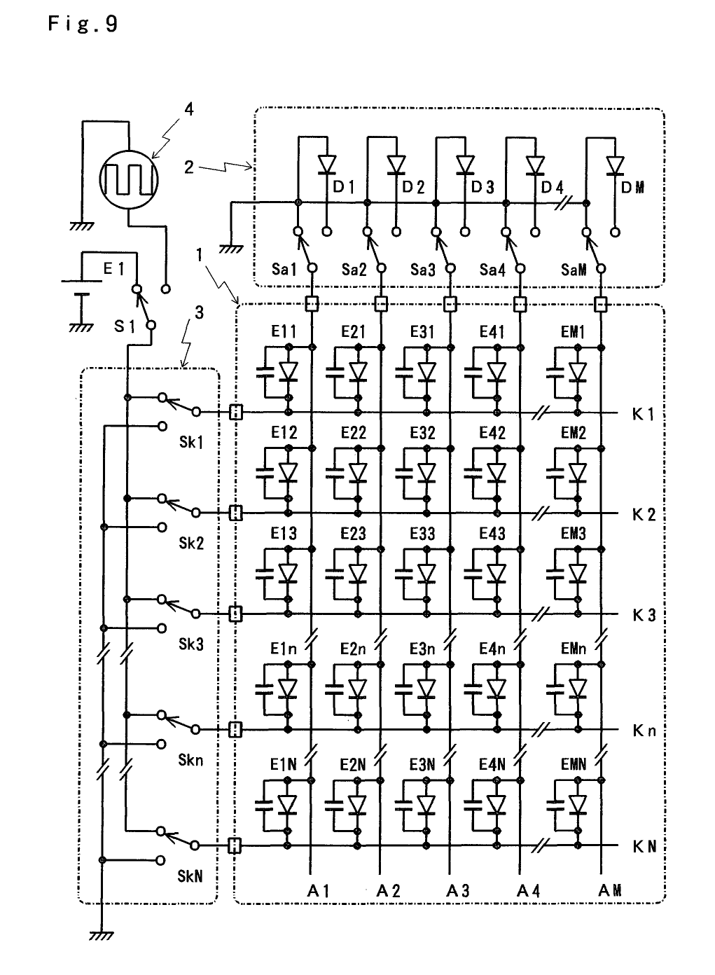

FIG. 9 shows a fifth embodiment of the display device according to the present invention. A reverse bias voltage can be applied to respective EL elements disposed to a display panel also in the embodiment shown in FIG. 9 likewise.

Note that since the display panel denoted by a reference numeral 1 and a data driver denoted by a reference numeral 2 in FIG. 9 have the same arrangements as those explained based on FIG. 4, the explanation thereof is not repeated.

In the arrangement shown in FIG. 9, a selection switch S1 is provided. The selection switch S1 acts such that it can select a positive pole voltage from a voltage source E1 for applying the reverse bias voltage to respective EL elements or a pulse voltage from the above pulse power supply 4.

When the selection switch S1, switches Sk1 to SkN as scan selection means disposed to a scan driver 3, and switches Sa1 to SaM as data selection means disposed to the data driver 2 are selected such that they are placed in a state shown in FIG. 9, respectively, the reverse bias voltage from the voltage source E1 can be applied to EL elements E11 to EMN disposed to the display panel 1, respectively.

The operation for applying the reverse bias voltage to the respective EL elements E11 to EMN is instantly performed to, for example, each one or each several frames as explained based on FIG. 8 also in the arrangement shown in FIG. 9. Since the same display operation as that of the embodiment explained based on FIG. 4 is performed except the case in which the reverse bias voltage is applied instantly to the respective EL elements E11 to EMN, a similar operation/working effect can be obtained.

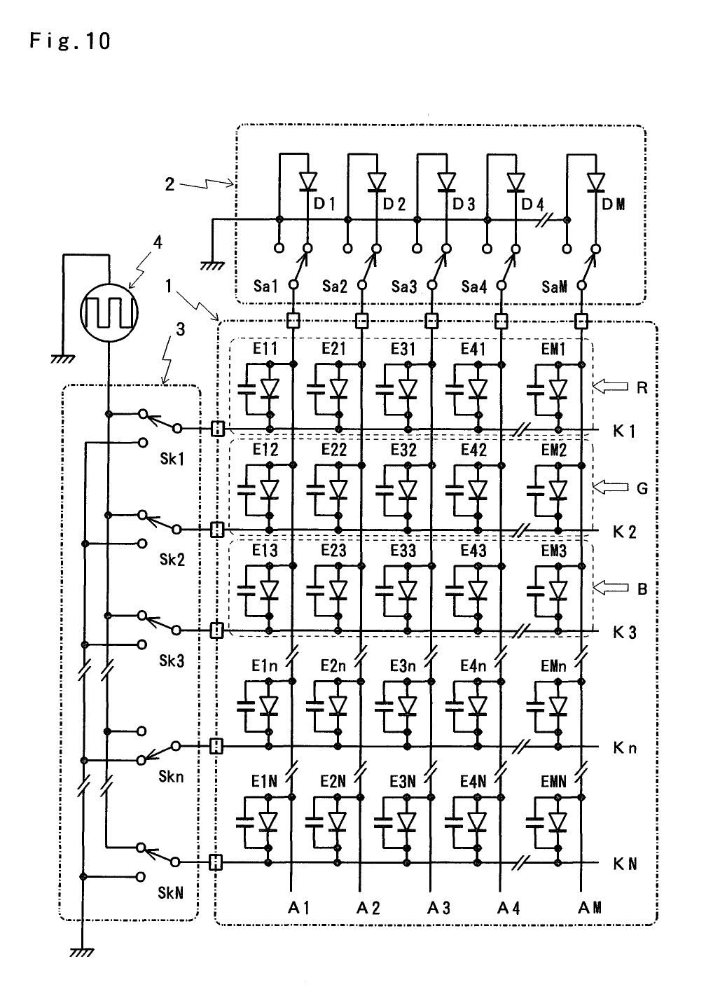

FIG. 10 shows a sixth embodiment of the display device according to the present invention. Note that since a data driver denoted by a reference numeral 2 and a scan driver denoted by a reference numeral 3 in FIG. 10 have the same arrangements as those explained based on FIG. 4, the explanation thereof is not repeated. An arrangement shown in FIG. 10 explains an example of a display operation of a display panel 1 to which EL elements having a light emitting color different to respective scan lines are disposed as in, for example, a color display and the like.

More specifically, the display panel 1 shown in FIG. 10 shows a case that an EL element which emits red color (R) is connected to a first scan line K1, an EL element which emits green color (G) is connected to a second scan line K2, and further an EL element which emits blue color (B) is connected to a third scan line K3 as an example and thereafter EL elements for emitting the respective colors are disposed to the respective scan lines in the same sequence although not shown.

In the EL elements disposed as described above, the amplitude (peak value) of a pulse voltage from a pulse power supply 4 is changed depending on the light emitting characteristics (light emitting efficiency) of the EL elements for emitting the respective colors. The amplitude of the pulse voltage from the pulse power supply 4 is changed in synchronization with a timing at which a scan of the scan lines is switched by the scan driver 3. As a result, an appropriate color balance can be realized because a pulse voltage having an optimum level to each emitted color can be applied.

Note that this is not limited to the case that the amplitude of the pulse voltage from the pulse power supply 4 is changed, and even if the frequency or the pulse width of the pulse voltage from the pulse power supply 4 is changed for each scan, the same effect can be obtained.

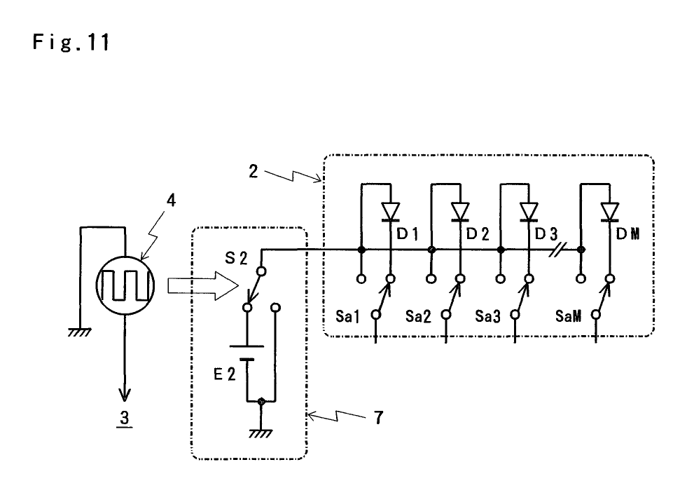

FIG. 11 shows a seventh embodiment according to the present invention and an arrangement in which a precharge circuit 7 is added to the data driver 2 shown in FIG. 4. Note that FIG. 11 omits illustration of the display panel 1 and the scan driver 3 shown in FIG. 4.

The precharge circuit 7 has a precharge switch S2 and a voltage source E2. The precharge switch S2 is switched in synchronization with the times at which a pulse voltage from a pulse power supply 4 rises and falls, and the voltage source E2 supplies a precharge voltage to a non-light-emitting line (ground side terminal) of a data driver 2 through the precharge switch S2. Note that the voltage value of the precharge voltage source E2 is set to a value approximately equal to or somewhat higher than the light emission threshold voltage (Vth) of EL elements.

Then, the precharge switch S2 is connected to the precharge voltage source E2 side when the pulse voltage of the pulse power supply 4 rises. With this operation, the voltage source E2 precharges a voltage in a forward direction to an EL element to be emitted in synchronization with the rush current supplied when the pulse voltage from the pulse power supply 4 rises.

Accordingly, since the EL element to be emitted is supplied with the rush current while being applied with the voltage in the forward direction from the voltage source E2, it can securely repeat a light emitting operation by the rush current.

In contrast, the precharge switch S2 is connected to a ground potential when the pulse voltage from the pulse power supply 4 falls. With this operation, a GND-GND reset shown FIG. 5(B) can be realized without trouble.

Note that, in the embodiments explained above, the change over time and the temperature dependency of the EL elements of the display panel can be compensated by appropriately controlling the amplitude (peak value), the frequency, and the pulse width of the pulse voltage of the pulse power supply 4 in accordance with the actually used time and the environmental temperature of the EL elements.

In the embodiments explained above, although a gradation control is realized by switching the switches Sa1 to SaM as the data selection means of the data driver, the gradation can be provided with gamma characteristics by appropriately controlling the number of the scan lines to which the pulse voltage is applied in addition the above operation.

Further, in the embodiments explained above, although the pulse voltage is applied to the plurality of scan lines from the one pulse power supply 4, each of the scan lines may be provided with the pulse power supply 4.

Further, the embodiments explained above show the example using the organic EL elements as the light-emitting elements disposed to the display panel. However, the display device according to the present invention can be also applied to a display device using other display panel provided with capacitive light-emitting elements having diode characteristics.

1. A display device comprising:
a plurality of signal lines and a plurality of scan lines which intersect with each other;
a plurality of light-emitting elements connected between the plurality of signal lines and the plurality of scan lines, respectively at the respective intersecting points of the scan lines and the signal lines;
a pulse power supply connected to at least one of the scan lines for outputting a pulse voltage;
a data driver having a plurality of data selection means for selectively connecting the signal lines to non-light-emitting terminals connected to a non-light-emitting potential or to light-emitting terminals connected to rectifying means for interrupting a current flowing from the signal lines; and
a scan driver having scan selection means for selectively connecting the scan lines to scan terminals connected to a scan selection potential,
wherein the light-emitting terminals are connected to the non-light-emitting potential through the rectifying means.

2. (canceled)

3. The display device according to claim 1, wherein the pulse power supply is connected to at least one scan line which is not scanned.

4. The display device according to claim 1, further comprising a dummy scan line to which at least one capacitive element, which does not contribute to display, is connected, wherein the pulse power supply is connected to the dummy scan line.

5. The display device according to claim 4, wherein the capacitive element is a capacitive element having a capacitance value according to the emitted color of the light-emitting elements connected to the signal lines to which the capacitive elements are connected.

6. The display device according to any of claims 1, 3, 4, and 5, further comprising gradation control means for controlling a timing at which the data selection means is switched according to gradation data.

7. The display device according to any of claims 1, 3, 4, and 5, further comprising dimmer control means for variably controlling the amplitude, the frequency, or the pulse width of the pulse voltage.

8. The display device according to any of claims 1, 3, 4, and 5, further comprising dimmer control means for controlling the number of the scan lines to which the pulse power supply is connected.

9. The display device according to any of claims 1, 3, 4, and 5, wherein pulse voltages, which are applied to at least two scan lines of the scan lines to which the pulse power supply is connected, have different phases.

10. The display device according to any of claims 1, 3, 4, and 5, further comprising a power recovery circuit for recovering a power flowing from the signal lines to the data driver in synchronization with the pulse voltage output from the pulse power supply.

11. A method of driving a display device which comprises a plurality of signal lines and a plurality of scan lines which intersect with each other and a plurality of light-emitting elements connected between the plurality of signal lines and the plurality of scan lines, respectively at the respective intersecting points of the scan lines and the signal lines, characterized in that there are executed:
a scan line setting operation for setting a scan line to be scanned to a scan selection potential as well as applying a pulse voltage to at least one of the scan lines which are not scanned; and
a light emission drive operation for supplying a rush current from the scan line to which the pulse voltage is applied to a light-emitting element to be emitted through a light-emitting element which is connected to a signal line to be selected and is not emitted a plurality of times in one scan period,
wherein the light emission drive operation performs an operation for connecting the signal line to be selected to rectifying means.

12. (canceled)

13. The method of driving the display device according to claim 11, wherein at the scan line setting step, the pulse voltage is applied to a dummy scan line to which at least one capacitive element, which does not contribute to display, is connected.

14. The method of driving the display device according to claim 13, wherein the capacitive element is a capacitive element having a capacitance value according to the emitted color or the area of a light-emitting element connected to a signal line to which the above capacitive element is connected.

15. The method of driving the display device according to claim 13 or 14, wherein the gradation of the display device is controlled by variably controlling the period in which the rush current is supplied to the light-emitting element to be emitted.

16. The method of driving the display device according to claim 13 or 14, wherein a dimmer control is executed by variably controlling the amplitude, the frequency, or the pulse width of the pulse voltage.

17. The method of driving the display device according to claim 13 or 14, wherein a dimmer control is executed by controlling the number of scan lines to which the pulse voltage is applied.

18. The method of driving the display device according to claim 13 or 14, wherein pulse voltages, which are applied to at least two scan lines of the scan lines to which the pulse power supply is connected, have different phases.

19. The method of driving the display device according to claim 13 or 14, wherein a power flowing from the signal lines to the data driver is recovered in synchronization with the pulse voltage.
